(19) United States
(12) Patent Application Publication
(10) Pub. No.: US 2014/0021277 A1
(43) Pub. Date: Jan. 23, 2014

(54) Vegetable Blending and Cutting Device and Method THereof

(71) Applicant: Xinghuan PAN, Rowland Heights, CA (US)

(72) Inventor: Xinghuan PAN, Rowland Heights, CA (US)

(21) Appl. No.: 13/551,596

(22) Filed: Jul. 17, 2012

(51) Int. Cl. B02C 18/22; B02C 18/12

(52) U.S. Cl. 241/28; 241/282.1

(57) ABSTRACT

A vegetable blending and cutting device includes a motorized unit, a food container having a discharging outlet, and a blade assembly supported within a bottom portion of the food container at a position above a bottom wall thereof to define a shredding area within the food container and to communicate with the discharging outlet, wherein the blade assembly is arranged for shredding the vegetables disposed within the shredding area that after the vegetables are shredded within the shredding area, the shredded vegetables are discharged out of the food container through the discharging outlet for controllably adjusting a shredding time of the shredded vegetables being stayed at the shredding area so as to control the shredded vegetable in a controllable delicate size manner.

### BACKGROUND OF THE PRESENT INVENTION

1. Field of Invention

The present invention relates to a food processing device, and more particularly to a vegetable blending and cutting device and a method thereof, which is adapted for effectively shredding vegetable in a controllable delicate size manner.

2. Description of Related Arts

In practice, vegetables are one of the common ingredients in food industry. For example, making Chinese dumplings requires a relatively large amount of finely chopped vegetables as the filling to be wrapped in the wrapper. Typically, the vegetables are chopped by a chefs knife because the delicate size of the chopped vegetables can be controlled by the chopping action and time. Since vegetable chopping is time consuming and inefficient when large quantities of food product are required. For restaurants and other food service industries, mechanical blending devices have been used.

A conventional blending device generally comprises a food container having a top opening, and a blade assembly rotatably supported at a bottom portion of the food container, wherein the blade assembly comprises a plurality of radially extending blades and arranged in such a manner that when the blade assembly is actuate to spin, the blades will slice, crush, and blend the vegetables being contacted with the blades at the bottom portion of the food container. However, such blending device has several drawbacks.

Since the blade assembly is located at the bottom portion of the food container, only the vegetables at the bottom portion of the food container will be shredded initially. The blade assembly will create a circular tornadic action which circulates the vegetables in the food container and chops them to the delicate size. Unlike the fluid content, the vegetables in solid form will not be evenly circulated within the food container. In other words, once the vegetables at the bottom portion of the food container are shredded, some of the shredded vegetables will stay at the bottom portion of the food container and will be kept blended by the blade assembly. It should be fine that the blending device is used for blending the vegetables in a paste form. However, for many vegetable recipes, the vegetables can only be blended in delicate size, such as making Chinese dumplings. Therefore, the conventional blending device cannot blend the vegetables to a desired consistency.

In order to prevent the vegetables being blended in paste form, the user may dispose small quantities of vegetables in the blending device to only fill at the bottom portion of the food container. Therefore, only small amount of vegetables will be shredded at one time. Likewise, the spinning speed of the blade assembly should be controlled at a relatively low speed to prevent the vegetables being over-shredded. As it is mentioned above, it is time consuming and inefficient when large quantities of food product are required.

### SUMMARY OF THE PRESENT INVENTION

The invention is advantageous in that it provides a vegetable blending and cutting device and a method thereof, which is adapted for effectively shredding vegetable in a controllable delicate size manner.

Another advantage of the invention is to provide a vegetable blending and cutting device and a method thereof, wherein the food container has a discharging outlet for releasing the shredded vegetables such that the vegetables can be continuously fed into the food container to enhance the efficiency of the present invention.

Another advantage of the invention is to provide a vegetable blending and cutting device and a method thereof, wherein the operation of the present invention is simple and easy by feeding the vegetables into the food container and discharging the shredded vegetables through the discharging outlet.

Another advantage of the invention is to provide a vegetable blending and cutting device and a method thereof, wherein the delicate size of the shredded vegetables can be controlled by the opening size of the outlet such that the spinning speed of the blade assembly can be set at a relatively high speed to enhance the efficiency of the present invention.

Another advantage of the invention is to provide a vegetable blending and cutting device and a method thereof, which does not require to alter the original mechanical design of the blending device, so as to minimize the manufacturing cost of the present invention.

Another advantage of the invention is to provide a vegetable blending and cutting device and a method thereof, wherein no expensive or complicated structure is required to employ in the present invention in order to achieve the above mentioned objects. Therefore, the present invention successfully provides an economic and efficient solution for shredding vegetable in a controllable delicate size manner.

Additional advantages and features of the invention will become apparent from the description which follows, and may be realized by means of the instrumentalities and combinations particular point out in the appended claims.

According to the present invention, the foregoing and other objects and advantages are attained by a vegetable blending and cutting device for shredding vegetables, comprising:

a motorized unit for generating a rotatable power;

a food container comprising a surrounding wall and a bottom wall, and defining a top opening, wherein the food container further has a discharging outlet; and

a blade assembly which is operatively linked to the motorized unit and is supported within the bottom portion of the food container at a position above the bottom wall thereof to define a shredding area within the food container and to communicate with the discharging outlet, wherein the blade assembly is arranged for shredding the vegetables disposed within the shredding area that after the vegetables are shredded within the shredding area, the shredded vegetables are discharged out of the food container through the discharging outlet for controllably adjusting a shredding time of the shredded vegetables being stayed at the shredding area so as to control the shredded vegetable in a controllable delicate size manner.

In accordance with another aspect of the invention, the present invention comprises a method of shredding vegetables in a controllable delicate size manner, comprising the steps of:

(a) disposing the vegetables in a food container from a top opening thereof;

(b) shredding the vegetables by a blade assembly within a shredding area defined within the food container; and

(c) after the vegetables are shredded within the shredding area, discharging the shredded vegetables through a discharging outlet of the food container, wherein the discharging outlet is communicating with the shredding area for controllably adjusting a shredding time of the shredded vegetables being stayed at the shredding area so as to control the shredded vegetable in a controllable delicate size manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a vegetable blending and cutting device according to a preferred embodiment of the present invention.

FIG. 2 is a sectional view of the vegetable blending and cutting device according to the above preferred embodiment of the present invention.

FIG. 3A is a perspective view of an adjustable gate of the vegetable blending to and cutting device according to the above preferred embodiment of the present invention.

FIG. 3B is an exploded perspective view of the adjustable gate of the vegetable blending and cutting device according to the above preferred embodiment of the present invention.

FIG. 4 is a flow diagram illustrating a method of shredding vegetables in a controllable delicate size manner through the vegetable blending and cutting device according to the above preferred embodiment of the present invention.

### DETAILED DESCRIPTION OF THE PREFERRED EMBODIMENT

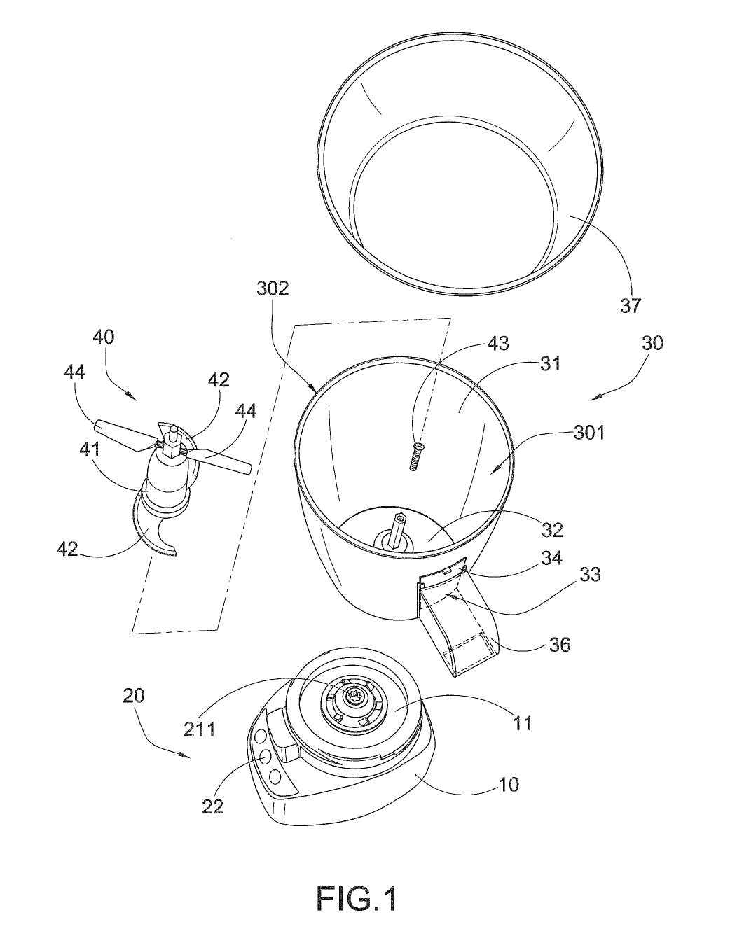

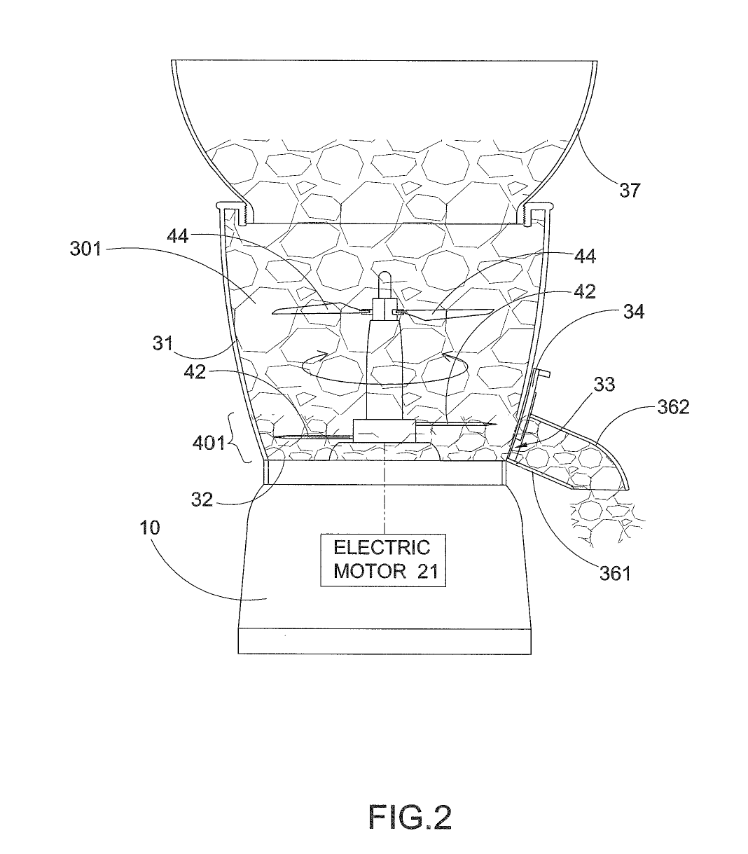

Referring to FIGS. 1 and 2 of the drawings, a vegetable blending and cutting device according to a preferred embodiment of the present invention is illustrated, wherein the vegetable blending and cutting device, which is arranged for finely shredding the vegetables in a controllable delicate size manner, comprises a base 10 and a motorized unit 20 received in the base 10 for generating a rotatable power.

The vegetable blending and cutting device further comprises a food container 30 detachably supported on the base 10 and a blade assembly 40 operatively driven by the motorized unit 20.

As shown in FIGS. 1 and 2, the food container 30 comprises a surrounding wall 31 and a bottom wall 32, and defining a food processing cavity 301 within the surrounding wall 31 and the bottom wall, a top opening 302 at a top edge of the surrounding wall 31, wherein the vegetables to be shredded is disposed within the food processing cavity 301. The food container 30 further has a discharging outlet 33.

The blade assembly 40 is supported within a bottom portion of the food container 30 at a position above the bottom wall 32 thereof to define a shredding area 401 within the food container 30, wherein the blade assembly 40 is operatively linked to the motorized unit 20 when the food container 30 is supported on the base 10.

Accordingly, the shredding area 401 is defined within the food processing cavity 301 of the food container 30 at the bottom portion thereof, wherein when the vegetables are disposed within the shredding area 401, the blade assembly 40 will shred the vegetables. In particular, the shredding area 401 is communicating with the discharging outlet 33, wherein after the vegetables are shredded within the shredding area 401, the shredded vegetables are discharged out of the food container 30 through the discharging outlet 33 for controllably adjusting a shredding time of the shredded vegetables being stayed at the shredding area 401 so as to control the shredded vegetable in a controllable delicate size manner.

It is worth mentioning that when the shredding time of the shredded vegetables being stayed at the shredding area 401 is prolonged, the blade assembly 40 will keep shredding the vegetables to reduce the size of the shredded vegetables. By shortening the shredding time, i.e. the shredded vegetables will stay at the shredding area shortly, the size of the shredded vegetables will be larger.

As shown in FIG. 1, the base 10 has a top seating platform 11 for supporting the bottom wall 32 of the food container 30, wherein the food container 30 can be stably supported on the top seating platform 11 of the base 10 when the motorized unit 20 is operated to actuate the blade assembly 40.

The motorized unit 20 comprises an electric motor 21 having a power shaft 211 upwardly extended to the top seating platform 11 of the base 10, and a control panel 22 provided at the base 10 to control the operation of the electric motor 21, such as the on-and-off power of the electric motor 21 and the rotatable speed of the power shaft 211.

According to the preferred embodiment, the food container 30 has a tapered cylindrical shape that a diameter of the top opening 302 is larger than a diameter of the bottom wall 32. Therefore, large quantities of vegetables can be disposed in the food processing cavity 301 of the food container 30 through the top opening 302 thereof.

The discharging outlet 33 is formed at the surrounding wall 31 of the food container 30 at the bottom portion thereof to communicate with the shredding area 401. In particular, the discharging outlet 33 is located adjacent to the shredding are 401 such that the shredded vegetables can be discharged out of the food container 30 through the discharging outlet 33 from the shredding area 401.

The blade assembly 40 comprises a center hub 41 supported above the bottom wall 32 of the food container 30 to operatively link to the power shaft 211 of the electric motor 21 and a plurality of blades 42 radially and outwardly extended from the center hub 41, wherein the blades 42 are arranged to spin in order to slice, crush, and blend the vegetables being contacted with the blades 42 within the shredding area 401. In other words, the shredding area 401 is defined around the blades 42 when the blades 42 are driven to spin. In particular, each of the blades 42 is formed at a predetermined shredding angle for enhancing the shredding action of the blades 42 when the blades 42 are driven to spin. The blades 42 are elevated from the bottom wall 32 of the food container 30 at a predetermined elevated distance.

As shown in FIGS. 1 and 2, the blades 42 are supported parallel to each other and are supported at different levels. According to the preferred embodiment, one of the blades 42 is formed as an upper blade while another blade 42 is formed as a lower blade which is positioned below the upper blade.

The evaluation of the blade assembly 40 is adjustable with respect to the bottom wall 32 of the food container 30. The blade assembly 40 further comprises a height adjustable member 43 movably coupled at the power shaft 211 of the electric motor 21, wherein when the height adjustable member 43 is selectively adjusted to support the center hub 41, the blades 42 are adjustably elevated from the bottom wall 32 of the food container 30. Preferably, the height adjustable member 43 is a screw rotatably, coaxially, and upwardly coupled at the center hub 41, such that when the height adjustable member 43 is rotated toward the bottom wall 32 of the food container 30, the blades 42 are adjustably lowered their evaluated levels with respect to the bottom wall 32 of the food container 30. When the height adjustable member 43 is rotated away from the bottom wall 32 of the food container 30, the blades 42 are adjustably evaluated their evaluated levels with respect to the bottom wall 32 of the food container 30. The evaluation range of the blade assembly 40 is about 5 to 6 mm. It is worth mentioning that the evaluation adjustment of the blade assembly 40 can control the shredded vegetable in a controllable delicate size manner. The size of the shredded vegetable will be relatively larger when the blades 42 are adjustably elevated at higher position. Likewise, the size of the shredded vegetable will be relatively smaller when the blades 42 are adjustably dropped down at lower position.

The blade assembly 40 further comprises a plurality of feeding guiders 44 radially and outwardly extended from the center hub 41 and supported above the blades 42, wherein when the center hub 41 is rotated, the feeding guiders 44 are driven to spin for pushing the vegetables within the food processing cavity 301 toward the shredding area 401. Accordingly, each of the feeding guiders 44, which is preferably made of plastic, is supported at a slanted position to push the vegetables downwardly. It is worth mentioning that when excessive amount of vegetables are disposed in the food processing cavity 301, the vegetables will be stunk therein even though the blades 42 are spinning. The feeding guiders 44 will create a spinning motion above the blades 42 to push the vegetables toward the shredding area 401. It is worth mentioning that each of the feeding guiders 44 does not have any sharp edge or is not made of metal for cutting the vegetables when the vegetables contact with the feeding guiders 44.

As shown in FIG. 2, the discharging outlet 33 is formed at the surrounding wall 31 of the food container 30 that the bottom edge of the discharging outlet 33 is defined at the bottom wall 32 of the food container 30. The top edge of the discharging outlet 33 is formed at the surrounding wall 31 of the food container 30 approximately aligning with the elevated level of the blades 42. In other words, the height of the discharging outlet 33 is about the same as the elevated distance of the upper blade 42 with respect to the bottom wall 32 of the food container 30. Preferably, the height of the discharging outlet 33 is configured corresponding to the elevated distance of the upper blade 42 with respect to the bottom wall 32 of the food container 30. Therefore, after the vegetables are shredded, especially at the area between the bottom wall 32 of the food container 30 and the blades 42, the shredded vegetables can be discharged out of the food container 30 through the discharging outlet 33. In addition, the shredded vegetables will be automatically discharged through the discharging outlet 33 by the spinning force of the blades 42.

According to the preferred embodiment, the present invention can control the shredding time of the shredded vegetables being stayed at the shredding area 401 to control the shredded vegetable in a controllable delicate size manner. In particular, the shredding time of the shredded vegetables can be controlled by the discharging rate of the shredded vegetables through the discharging outlet 33. In other words, by controlling the opening size of the discharging outlet 33, the shredding time of the shredded vegetables can be controlled.

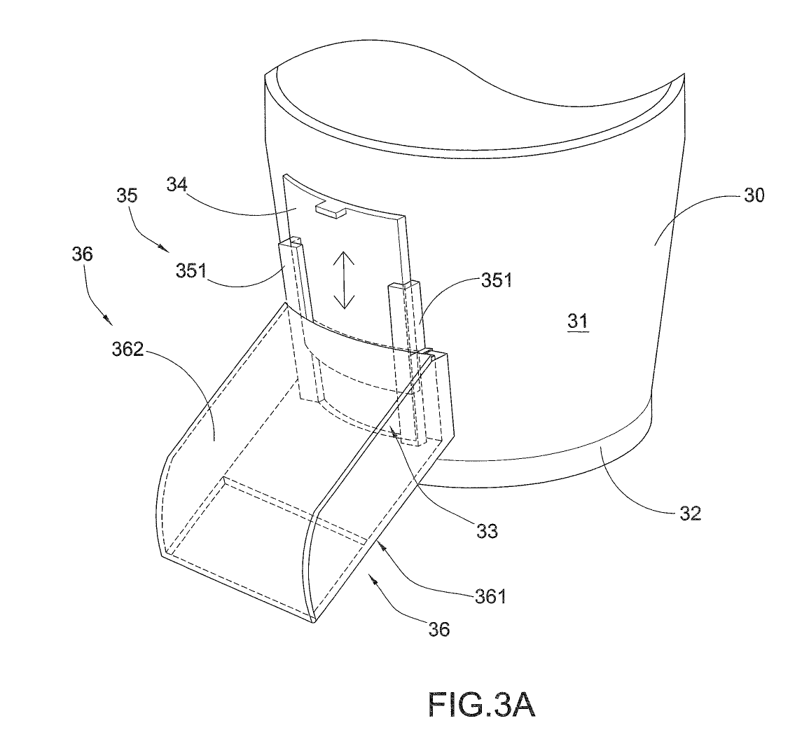

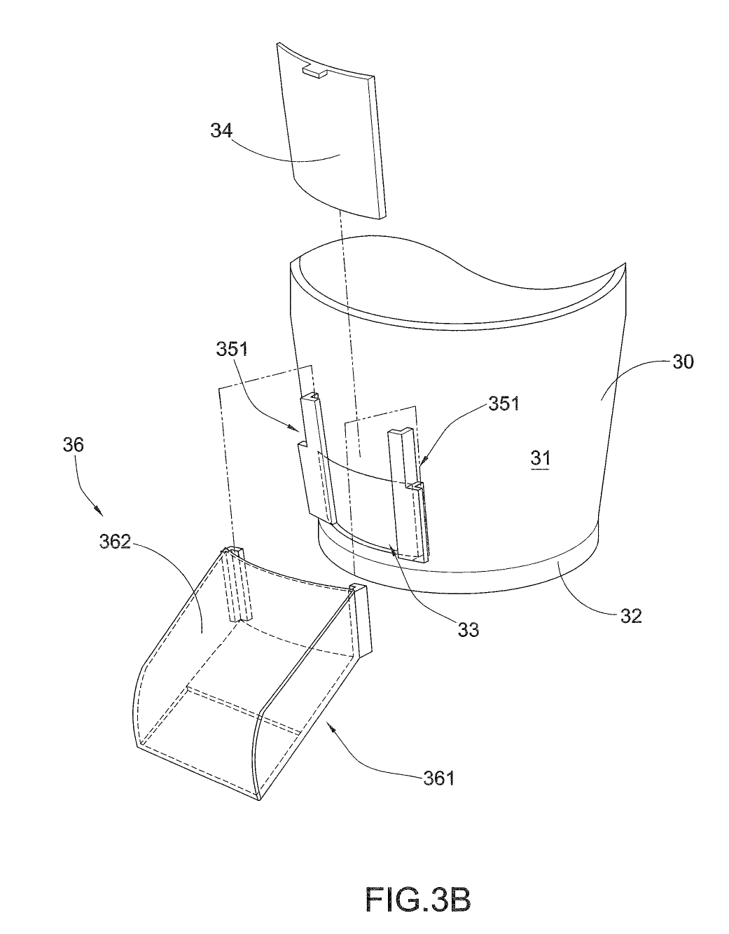

The food container 30 further comprises an adjustable gate 34 movably coupled at the surrounding wall 31 to selectively adjust the opening size of the discharging outlet 33, as shown in FIG. 3A. When the adjustable gate 34 is moved to enlarge the opening size of the discharging outlet 33, the discharging rate of the shredded vegetables through the discharging outlet 33 will be increased. Therefore, the shredding time of the shredded vegetables being stayed at the shredding area 401 will be reduced. Likewise, when the adjustable gate 34 is moved to reduce the opening size of the discharging outlet 33, the discharging rate of the shredded vegetables through the discharging outlet 33 will be decreased. Therefore, the shredding time of the shredded vegetables being stayed at the shredding area 401 will be increased.

As shown in FIGS. 2 and 3A, the adjustable gate 34 is slidably coupled at the surrounding wall 31 of the food container 30 via a sliding assembly 35, wherein the sliding assembly 35 comprises two sliding tracks 351 spacedly formed at the surrounding wall 31 along two sides of the discharging outlet 33, wherein two side edges of the adjustable gate 34 are slidably engaged with the sliding tracks 351 respectively such that the adjustable gate 34 is slid downwardly to close the discharging outlet 3 and is slid upwardly to adjustably enlarge the discharging outlet 33.

It is worth mentioning that the discharging outlet 33 is upwardly extended from the bottom wall 32 of the food container 30, such that when the adjustable gate 34 is upwardly slid to initially open up the discharging outlet 33, the shredded vegetables at the bottom of the food container 30 will be discharged out of the discharging outlet 33 so as to prevent the shredded vegetables being accumulated at the bottom of the food container 30 which may prolong the shredding time of the shredded vegetables.

Preferably, each of the sliding tracks 351 has a L-shaped cross section to define a sliding channel thereat to slidably engage with the respective side edge of the adjustable gate 34, as shown in FIGS. 3A and 3B. Preferably, the width of the adjustable gate 34 is larger than the width of the discharging outlet 33.

According to the preferred embodiment, the food container 30 further comprises a discharging spout 36 extended from the discharging outlet 33 for guiding the shredded vegetables out of the shredding area 401. The discharging spout 36 comprises a slanted guiding platform 361 downwardly and outwardly extended from the bottom side of the discharging outlet 33 such that when the shredded vegetables are discharged out of the discharging outlet 33, the shredded vegetables will be guided to slide at the slanted guiding platform 361 to a desired container. Preferably, the discharging spout 36 has a tubular structure, such as a hollow rectangular cross section, encircling with the discharging outlet 33, wherein an elongated space is formed between a top wall of the discharging spout 36 and the surrounding wall 31 such that the adjustable gate 34 can be slid at the elongated space to open or close the discharging outlet 33.

In addition, discharging spout 36 further comprises a discharging guide 362 extended from the top wall of the discharging spout 36, wherein the discharging guide 362 has a downward curving structure such that when the shredded vegetables are discharged out of the discharging outlet 33, the shredded vegetables will not be splashed to anywhere.

Accordingly, the discharging spout 36 is detachably coupled to the surrounding wall 31 to align with the discharging outlet 33 thereat. In particular, the discharging spout 36 is slidably coupled to the surrounding wall 31 via the sliding assembly 35, wherein two side edges of the discharging spout 36 are slidably and detachably coupled the sliding tracks 351 respectively such that the discharging spout 36 is slid downwardly to alignedly encircle the discharging outlet 3 and is slid upwardly to detach from the surrounding wall 31 of the food container 30.

It is worth mentioning that since the shredded vegetables are discharged out of the food container, the vegetables can be continuously fed in the food container 30 through the top opening 302 at the same time when the shredded vegetables discharges out of the food container 30 through the discharging outlet 33. Preferably, the food container 30 further comprises a guiding funnel 37 detachably supported thereon for guiding the vegetables being fed in the food container 30. The guiding funnel 37 has an enlarged opening and a bottom opening. The diameter of the bottom opening of the guiding funnel 37 is slightly smaller than the diameter of the top opening 302 of the food container 30 such that the bottom opening of the guiding funnel 37 can be rested at the rim of the top opening 302 of the food container 30. The diameter of the enlarged opening of the guiding funnel 37 is larger than the diameter of the top opening 302 of the food container 30 and is coaxially aligned with the bottom opening of the guiding funnel 37. Therefore, when the guiding funnel 37 is placed on top of the food container 30, the vegetables can be disposed in the guiding funnel 37 and can be delivered into the food container 30. In other words, the guiding funnel 37 will increase the volume of the food container 30 to contain the vegetables. Preferably, the bottom opening of the guiding funnel 37 is coupled with the top opening 302 of the food container 30 via the threaded structure as shown in FIG. 2.

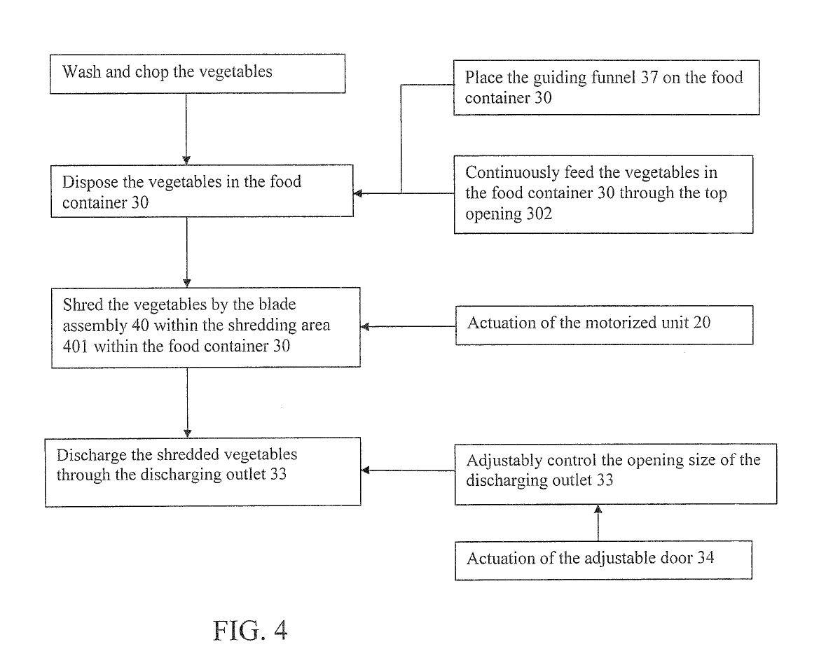

As shown in FIG. 4, in order to operate the vegetable blending and cutting device, the present invention further provides the vegetables shredding method which comprises the following steps.

(A) Wash and chop the vegetables into a predetermined size. In order to enhance the efficiency of the blade assembly 40, the vegetables are chopped to have a size larger than the shredded vegetables such that the food container 30 can contain more amounts of the vegetables.

(B) Dispose the vegetables in the food container 30 from the top opening 302 thereof. After the vegetables are chopped, the vegetables can be filled in the food container 30 until it is full. In addition, the guiding funnel 37 can be supported on the food container 30 to guide the vegetables feeding thereto.

(C) Shred the vegetables by the blade assembly 40 within the shredding area 401 within the food container 30. By actuating the motorized unit 20, the blades 42 are driven to spin to slice, crush, and blend the vegetables being contacted with the blades 42 within the shredding area 401.

(D) After the vegetables are shredded within the shredding area 401, discharge the shredded vegetables through the discharging outlet 33 of the food container 34. At the mean time, the shredding time of said shredded vegetables being stayed at said shredding area will be for controllably adjusted to control the shredded vegetable in a controllable delicate size manner.

Accordingly, the step (B) further comprises the step of continuously feeding the vegetables in the food container 30 through the top opening 302 at the same time when the shredded vegetables discharges out of the food container 30 through the discharging outlet 33. Therefore, the user does not need to turn off the motorized unit 20 and to discharge the shredded vegetables from the top opening 302 of the food container 30.

The step (D) further comprises a step of adjustably controlling the opening size of the discharging outlet 33 to control the discharging rate of the shredding area 401. The adjustable gate 34 is upwardly slid to open up of the discharging outlet 33, wherein the adjustable gate 34 can be gradually slid upward to gradually increase the opening size of the discharging outlet 33. In order to decrease the discharging rate, the adjustable gate 34 can be slid downwardly to reduce the opening size of the discharging outlet 33.

It is worth mentioning that when the motorized unit 20 is started to actuate the blade assembly 40 for shredding the vegetables initially, the adjustable gate 34 is preferably stayed at the closed position. After a predetermined amount of vegetables is shredded, the adjustable gate 34 will be slid upwardly to initially open up the discharging outlet 33.

It should be appreciated that the discharging outlet 33 can be formed at the bottom wall 32 of the food container 30 while the adjustable gate 34 can be slidably coupled at the bottom wall of the food container 30 to control the opening size of the discharging outlet 33.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A vegetable blending and cutting device for shredding vegetables, comprising:
a motorized unit for generating a rotatable power;
a food container comprising a surrounding wall and a bottom wall, and defining a top opening, wherein said food container further has a discharging outlet; and
a blade assembly which is operatively linked to said motorized unit and is supported within said bottom portion of said food container at a position above said bottom wall thereof to define a shredding area within said food container and to communicate with said discharging outlet, wherein said blade assembly is arranged for shredding said vegetables disposed within said shredding area that after said vegetables are shredded within said shredding area, said shredded vegetables are discharged out of said food container through said discharging outlet for controllably adjusting a shredding time of said shredded vegetables being stayed at said shredding area so as to control said shredded vegetable in a controllable delicate size manner.

2. The device, as recited in claim 1, wherein said discharging outlet is formed at said surrounding wall of said food container at said bottom portion thereof to communicate with said shredding area.

3. The device, as recited in claim 1, wherein said food container further comprises an adjustable gate movably coupled at said surrounding wall to selectively adjust an opening size of said discharging outlet.

4. The device, as recited in claim 2, wherein said food container further comprises an adjustable gate movably coupled at said surrounding wall to selectively adjust an opening size of said discharging outlet.

5. The device, as recited in claim 3, wherein said food container further comprises two sliding tracks spacedly formed at said surrounding wall along two sides of said discharging outlet, wherein two side edges of said adjustable gate are slidably engaged with said sliding tracks respectively such that said adjustable gate is slid downwardly to close said discharging outlet and is slid upwardly to adjustably enlarge said discharging outlet.

6. The device, as recited in claim 4, wherein said food container further comprises two sliding tracks spacedly formed at said surrounding wall along two sides of said discharging outlet, wherein two side edges of said adjustable gate are slidably engaged with said sliding tracks respectively such that said adjustable gate is slid downwardly to close said discharging outlet and is slid upwardly to adjustably enlarge said discharging outlet.

7. The device, as recited in claim 1, wherein said food container further comprises a discharging spout extended from said discharging outlet for guiding said shredded vegetables out of said shredding area.

8. The device, as recited in claim 6, wherein said food container further comprises a discharging spout extended from said discharging outlet for guiding said shredded vegetables out of said shredding area.

9. The device, as recited in claim 1, wherein said food container has a tapered cylindrical shape that a diameter of said top opening is larger than a diameter of said bottom wall.

10. The device, as recited in claim 8, wherein said food container has a tapered cylindrical shape that a diameter of said top opening is larger than a diameter of said bottom wall.

11. The device, as recited in claim 1, further comprising a base receiving said motorized unit therein, wherein said food container is detachably coupled at said base to operatively link said motorized unit to said blade assembly.

12. The device, as recited in claim 10, further comprising a base receiving said motorized unit therein, wherein said food container is detachably coupled at said base to operatively link said motorized unit to said blade assembly.

13. A method of shredding vegetables in a controllable delicate size manner, comprising the steps of:
(a) disposing said vegetables in a food container from a top opening thereof;
(b) shredding said vegetables by a blade assembly within a shredding area defined within said food container; and
(c) after said vegetables are shredded within said shredding area, discharging said shredded vegetables through a discharging outlet of said food container, wherein said discharging outlet is communicating with said shredding area for controllably adjusting a shredding time of said shredded vegetables being stayed at said shredding area so as to control said shredded vegetable in a controllable delicate size manner.

14. The method, as recited in claim 13, wherein said discharging outlet is formed at a surrounding wall of said food container at a bottom portion thereof to communicate with said shredding area.

15. The method, as recited in claim 13, wherein the step (c) further comprises a step of adjustably controlling an opening size of said discharging outlet to control a discharging rate of said shredding area.

16. The method, as recited in claim 14, wherein the step (c) further comprises a step of adjustably controlling an opening size of said discharging outlet to control a discharging rate of said shredding area.

17. The method, as recited in claim 13, before the step (a), further comprising a step of continuously feeding said vegetables in said food container through said top opening at the same time when said shredded vegetables discharges out of said food container through said discharging outlet.

18. The method, as recited in claim 16, before the step (a), further comprising a step of continuously feeding said vegetables in said food container through said top opening at the same time when said shredded vegetables discharges out of said food container through said discharging outlet.

19. The method, as recited in claim 13, wherein said vegetables are chopped before feeding into said food container which has a tapered cylindrical shape that a diameter of said top opening is larger than a diameter of a bottom wall.

20. The method, as recited in claim 18, wherein said vegetables are chopped before feeding into said food container which has a tapered cylindrical shape that a diameter of said top opening is larger than a diameter of a bottom wall.
